(19) United States
(12) Patent Application Publication
(10) Pub. No.: US 2008/0002754 A1
(43) Pub. Date: Jan. 3, 2008

(54) Method and system for measuring the amount of fluid disposed on an object

(76) Inventors: Shaoyong Liu, Singapore (SG); Jing Fang Pan, Singapore (SG); Yi Z. Yao, Singapore (SG); Kelvin K. Ang, Singapore (SG)

Correspondence Address: WAGNER, MURABITO & HAO LLP, 123 Westridge Drive, Watsonville, CA, 95076, US

(21) Appl. No.: 11/477,297

(22) Filed: Jun. 28, 2006

(51) Int. Cl. G01N 25/00

(52) U.S. Cl. 374/14

(57) ABSTRACT

The present invention pertains to a method for measuring the amount of fluid disposed on an object. The method includes weighing the object with the fluid disposed thereon. The object is then heated at a substantially constant temperature until all the fluid disposed thereon is removed, where a substantially constant temperature is maintained from the point at which the heating is initiated. The object is then re-weighed. The weight of the fluid disposed on the object is then calculated by subtracting the weight of the object after heating from the weight of the object before heating.

### TECHNICAL FIELD

The present invention pertains to a method and system for measuring the amount of lubricating fluid applied to a hard disk drive screw.

### BACKGROUND ART

Hard disk drives (HDDs) are used in almost all computer systems. In general, HDDs store data on hard disks arranged in a platter configuration. An actuator arm with a magnetic read/write transducers or heads moves over the surface of the hard disks when spun to effectuate data transfer. These components are contained within a housing, which is sealed to reduce contamination and increase the performance and reliability of the HDD.

Since the first HDD was developed nearly 50 years ago, HDDs have continually evolved. Given the increase in storage capacity over the years, HDDs are now making their way into many different consumer products. Since products like handheld computer systems and portable music players are preferably small and lightweight, HDDs are continuing to decrease in physical size and increase in complexity. Moreover, these applications demand greater ruggedness and reliability. Thus, these demands have lead to tight operational tolerances within the HDD, where even a slight deviation could cause operational errors or failures.

To remain within the operational tolerances of each component comprising the HDD, each subcomponent must be assembled and installed according to the specifications set forth by the HDD manufacturer. These specifications cover every component of every assembly, including the screws used to assemble the HDD. Among the many specifications covering HDD screws, specifications exist concerning the thickness of the lubricating fluid applied to the screws before assembly into the HDD.

Lubricating fluid is applied to HDD screws to produce more accurate and consistent torque values when tightened. As such, the application of too little lubricating fluid may result in inaccurate torque values. However, if too much lubricating fluid is applied, the lubricating fluid can migrate and contaminate other components within the HDD. This cross-contamination can ultimately cause operational errors, or even failure of the HDD. Thus, it is important to apply the proper amount of lubricating fluid to the HDD screws before assembly into the HDD.

Devices used to perform thermogravimetric analysis are used to monitor the amount of lubricating fluid applied to HDD screws. As shown in FIG. 1, a conventional thermogravimetric analyzer (TGA) 100 can measure the weight of a sample in sample pan 105 as the sample is heated by heating element 110. Tare weight pan 115 suspended from balance arm 120 is used to accommodate different sample pans. Sample thermocouple 125 and control thermocouple 130 measure temperature change within alumina atmosphere tube 135 around the sample placed in sample pan 105. To further control the test environment, external purge gases may be directed through purge gas inlet 140, over the sample being tested, and out purge gas outlet 145.

FIG. 2 is a graph from a TGA showing changes in HDD screw weight 210 as a function of temperature during testing. As the screw is heated within the TGA, the weight begins to change as the lubricating fluid is removed. By the time the TGA reaches about 175 degress Celcius, all the lubricating fluid is removed. As such, weight change 220 represents the weight of the lubricating fluid applied to the screw.

Although TGAs are commonly used to monitor the amount of lubricating fluid applied to a HDD screw, the device presents some significant drawbacks when used for this purpose. First, given the need to heat the TGA from room temperature and due to its slow increase in temperature throughout the test, each HDD screw test takes about 30 minutes. Although this has been adequate in the past with lower production volumes, sample quantities have increased at a such a rate that now monitoring even one pre-production run of screws could take over a day.

Another drawback of the TGA method is the inability to test more than one screw at a time given the small size of the sample pan and the alumina atmosphere tube. In addition to adding significant time to the testing procedure, the inability to test multiple screws simultaneously creates inaccurate and inconsistent results. The inaccuracy and inconsistency is due primarily to variations in heating and the testing atmosphere within the TGA when testing screws.

In sum, the shortcomings of the TGA discussed above create a significant bottleneck in the manufacturing of HDDs. Not only does long test duration expend valuable resources and create inefficient quality control, but it also prevents adequate monitoring of the amount of lubricating fluid applied to the HDD screws by limiting the number of samples tested. Furthermore, the inaccuracy and inconsistencies created by testing one screw at a time causes added time and expense. Thus, given the importance of the aforementioned monitoring to HDD operation, a need exists to more efficiently and economically monitor the amount of lubricating fluid applied to HDD screws.

### SUMMARY

The present invention pertains to a method for measuring the amount of fluid disposed on an object. The method includes weighing the object with the fluid disposed thereon. The object is then heated at a substantially constant temperature until all the fluid disposed thereon is removed, where a substantially constant temperature is maintained from the point at which the heating is initiated. The object is then re-weighed. The weight of the fluid disposed on the object is then calculated by subtracting the weight of the object after heating from the weight of the object before heating.

### BRIEF DESCRIPTION OF DRAWINGS

FIG. 1 is a conventional thermogravimetric analyzer.

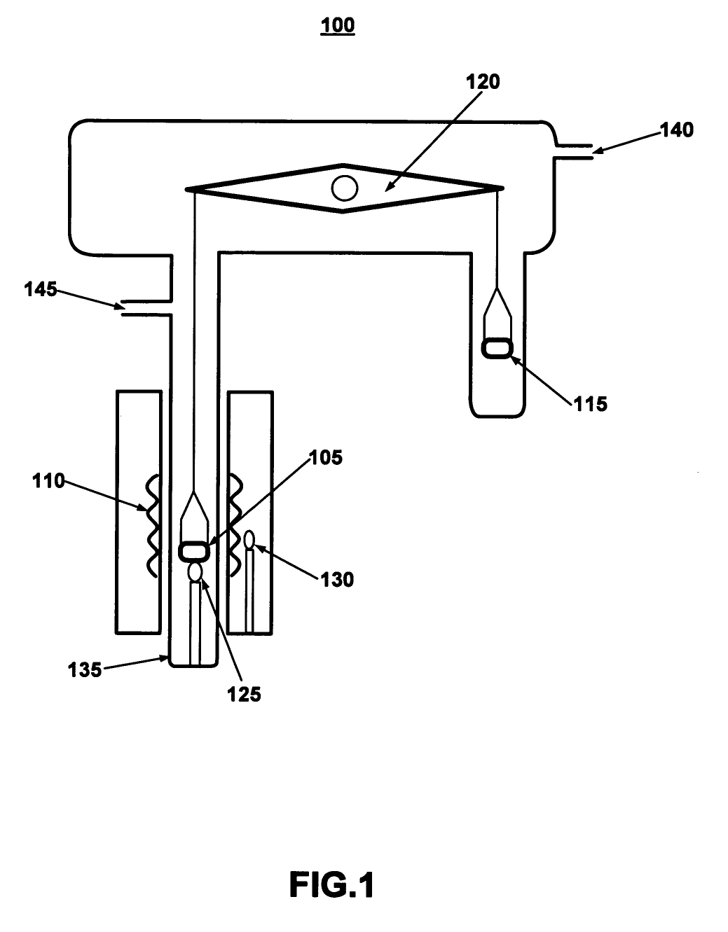

FIG. 2 is a graph from a thermogravimetric analyzer showing changes in hard disk drive screw weight as a function of temperature during testing.

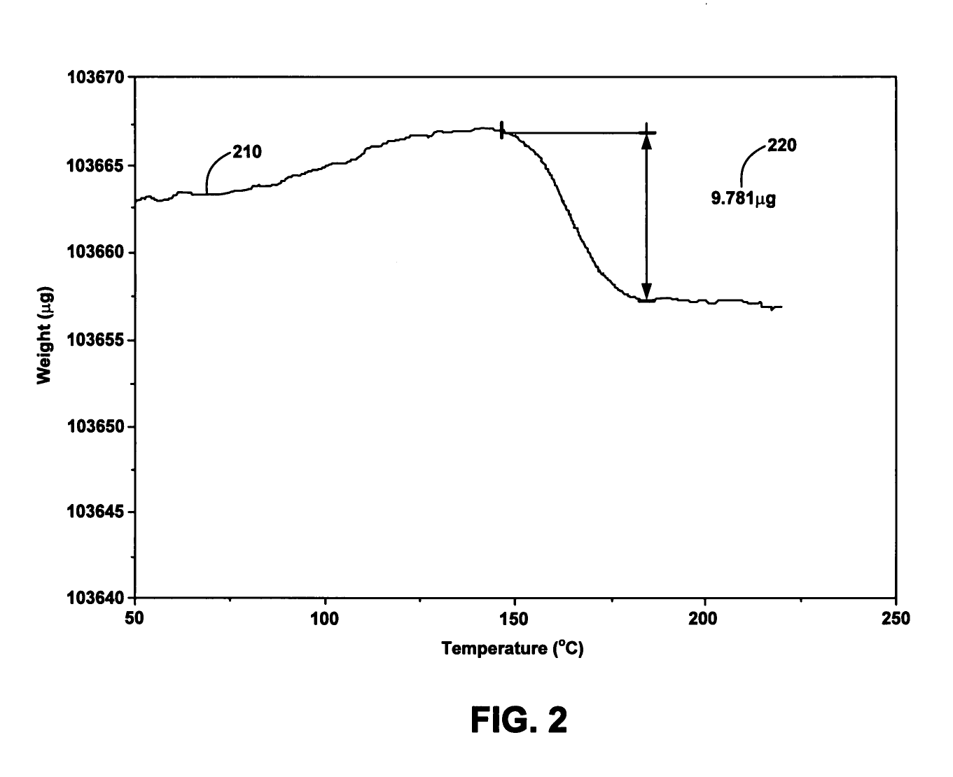

FIG. 3 is an overview of a quality control system for monitoring the amount of lubricating fluid applied to hard disk drive screws in accordance with one embodiment of the present invention.

FIG. 4 is a lubricating fluid quantity testing system in accordance with one embodiment of the present invention.

FIG. 5 is a quality control process for monitoring the amount of lubricating fluid applied to hard disk drive screws in accordance with one embodiment of the present invention.

FIG. 6 is a method for measuring the amount of the fluid disposed on an object or objects selected from a batch of objects in accordance with one embodiment of the present invention.

FIG. 7 is a graph comparing the weight loss due to removal of lubricating fluid when using a conventional method and embodiments of the present invention.

FIG. 8 is a table of the data presented in the graph of FIG. 7, which compares the weight loss due to removal of lubricating fluid when using a conventional method and when using embodiments of the present invention.

### DETAILED DESCRIPTION OF THE EMBODIMENTS

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention. For example, it should be understood that although the discussion will refer to lubricating fluid on screws, such specificity is merely for convenience and to simplify the discussion. As such, the methods and systems of the embodiments of the present invention can be applied to any object with a fluid disposed thereon.

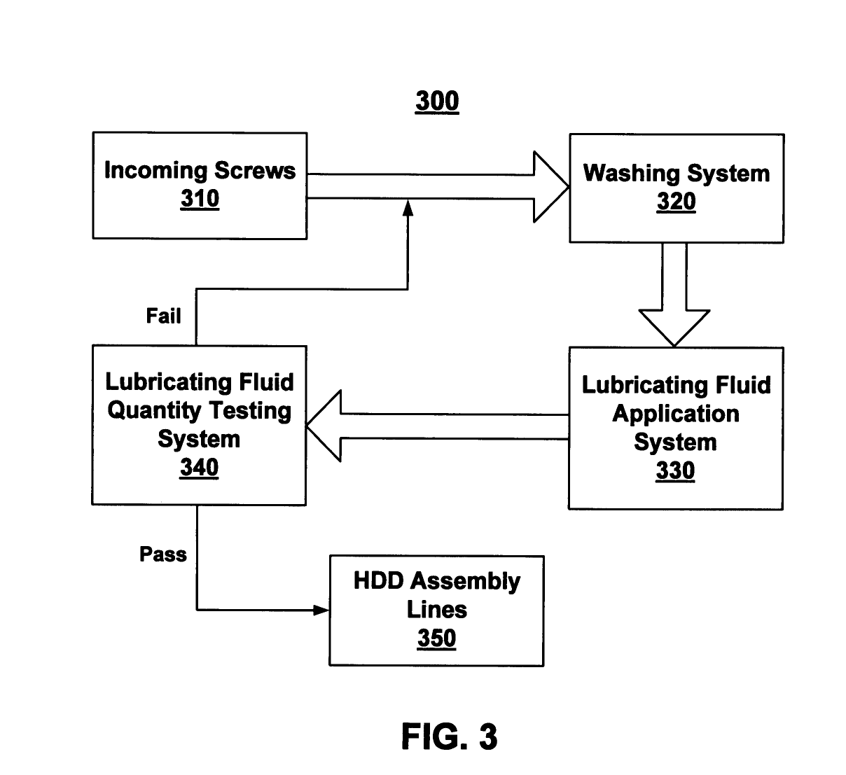

FIG. 3 shows components of quality control system 300 for monitoring the amount of lubricating fluid applied to HDD screws in accordance with one embodiment of the present invention. In general, quality control of the lubricating fluid applied to hard disk drive (HDD) screws is important to ensure accurate and consistent torque values and prevent cross-contamination. In the FIG. 3 embodiment, quality control system 300 includes incoming screws 310, washing system 320, lubricating fluid application system 330, lubricating fluid quantity testing system 340, and HDD assembly lines 350.

Incoming screws 310 represent a batch of HDD screws that will ultimately be used in HDDs if “passed” by lubricating fluid quantity testing system 340. After the batch of screws is compiled, incoming screws 310 enter washing system 320. In one embodiment, incoming screws 310 enter washing system 320 to remove any dirt, grease, lubricating fluid, or the like. It should be appreciated that the removal of undesirable deposits improves the accuracy and precision of quality control system 300, and thus, improves the quality of its pass/fail determinations. After incoming screws 310 are washed in washing system 320, lubricating fluid is applied by lubricating fluid application system 330. The amount of lubricating fluid applied to incoming screws 310 may then be measured by lubricating fluid quantity testing system 340.

In one embodiment of the present invention, one or more of the screws are selected from the batch to be tested by lubricating fluid quantity testing system 340. The screws are passed if the amount of lubricating fluid applied to the screws under test falls within the desired range, and failed if the amount of lubricating fluid falls outside of the desired range. If failed, the screws are sent back to washing system 320 to be rewashed, then to lubricating fluid application system 330 to be recoated, and finally back to lubricating fluid quantity testing system to be retested. If the batch of screws passes, then the batch, excluding those screws under test, are sent to HDD assembly lines 350 for use in the assembly of HDDs.

To summarize the operation of quality control system 300, a batch of HDD screws enters quality control system 300 as incoming screws 310, is washed in washing system 320, is coated with lubricating fluid in lubricating fluid application system 330, and then one or more screws selected from the batch of incoming screws 310 is tested in lubricating fluid quantity testing system 340. If the screws tested are passed, the batch of screws is passed on to HDD assembly lines 350 for use in the assembly of HDDs. If the screws tested are failed, then the batch is sent back to washing system 320 to be rewashed, then passed to lubricating fluid application system 330 to be recoated with lubricating fluid, and then passed to lubricating fluid quantity testing system 340 to be retested. In one embodiment, this process is repeated until the batch is passed.

It should be appreciated that in one embodiment, lubricating fluid quantity testing system 340 utilizes a destructive testing method. As such, after comparing the measured amount of lubricating fluid applied to the screw or screws under test to a desired value or range of values, all of incoming screws 310 except for those under test are either passed or failed.

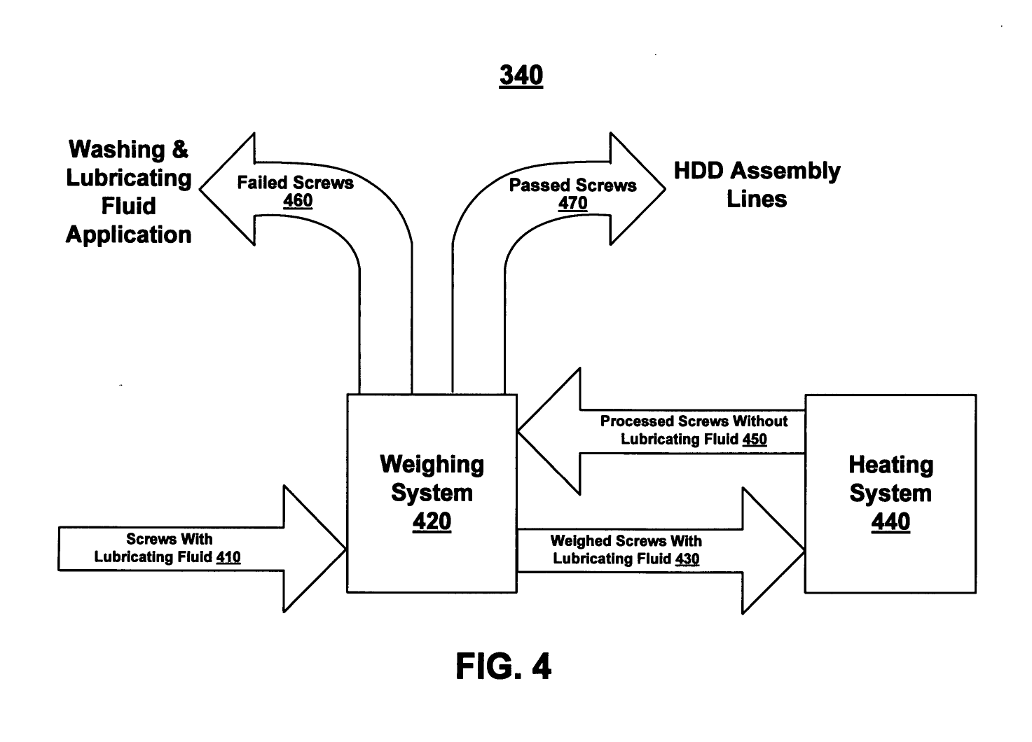

FIG. 4 shows one embodiment of lubricating fluid quantity testing system 340 for monitoring the amount of lubricating fluid disposed on an object. Lubricating fluid quantity testing system 340 accurately monitors the amount of lubricating fluid applied to HDD screws to ensure accurate and consistent torque values and prevent cross-contamination from excess lubricating fluid on screws used in HDD assemblies. FIG. 4 shows screws with lubricating fluid 410, weighting system 420, weighed screws with lubricating fluid 430, heating system 440, processed screws without lubricating fluid 450, failed screws 460, and passes screws 470.

Referring to FIG. 4, screws with lubricating fluid 410 enter weighing system 420 to determine the weight of the screws and the lubricating fluid. Screws with lubricating fluid 410 may include one or more sample screws chosen from the batch of incoming screws. In one embodiment, screws with lubricating fluid 410 may be weighed individually. In another embodiment, screws with lubricating fluid 410 may be weighed simultaneously. Thus, embodiments of the present invention represent a significant advantage over conventional methods limited to testing a single screw, as embodiments of the present invention allow multiple screws to be weighed before being heated, thereby increasing the speed, accuracy, and consistency of the process.

After being weighed in weighing system 420, weighed screws with lubricating fluid 430 enter heating system 440. Heating system 440 heats weighed screws with lubricating fluid 430 at a substantially constant temperature until all lubricating fluid is removed. It should be understood that a substantially constant temperature may include slight variations from the substantially constant temperature throughout heating. Moreover, it should be understood that this substantially constant temperature is maintained from the point at which heating is initiated.

In one embodiment, heating system 440 utilizes an oven preheated to a desired temperature. In this embodiment, weighed screws with lubricating fluid 430 are placed in the preheated oven until all lubricating fluid is removed. In another embodiment, heating system 440 utilizes a micro-flame jet. The micro-flame jet is directed toward weighed screws with lubricating fluid 430 until all lubricating fluid is removed. In each of these embodiments of the present invention, the time required to remove the lubricating fluid is greatly reduced since the heat source is not heated from room temperature. Consequently, the time to test weighed screws with lubricating fluid 430 is reduced substantially as compared to conventional systems. For example, in one embodiment, the testing time is reduced from about 30 minutes to about one minute.

Moreover, embodiments of heating system 440 of the present invention allow the heating of multiple screws, which significantly reduces the time required to remove the lubricating fluid. For example, instead of taking five hours to heat ten screws as required by conventional systems, one embodiment of present invention can heat the ten screws in as little as one minute if heated simultaneously or as little as ten minutes if heated individually. In other embodiments, the time to heat screws may be even further reduced. Thus, embodiments of the present invention significantly reduce the time it takes to heat one or more screws until all the lubricating fluid disposed thereon is removed.

Once the lubricating fluid is removed via heating system 440, processed screws without lubricating fluid 450 are then reweighed in weighing system 420 to determine the amount of lubricating fluid removed from the screws. In one embodiment, the screws are weighed individually. In this embodiment, the weight of the screw after the lubricating fluid is removed is subtracted from the weight of the screw obtained previously when the screw was coated with lubricating fluid. The result represents the amount of lubricating fluid removed from the screw. In another embodiment, the screws are weighed simultaneously. In this embodiment, the weight of the screws after the lubricating fluid is removed is subtracted from the weight of the screws obtained previously when the screws were coated with lubricating fluid. This result may then be divided by the number of screws to obtain an average value for the fluid removed from each screw. In either embodiment, once the amount of fluid on each screw is determined, this value is then compared to a range of acceptable values to determine if the batch, represented by the sample screws tested, passes or fails. Failed screws 460 are rewashed and recoated with lubricating fluid before being retested. Passed screws 470 are sent to the HDD assembly lines for use in assembly of HDDs.

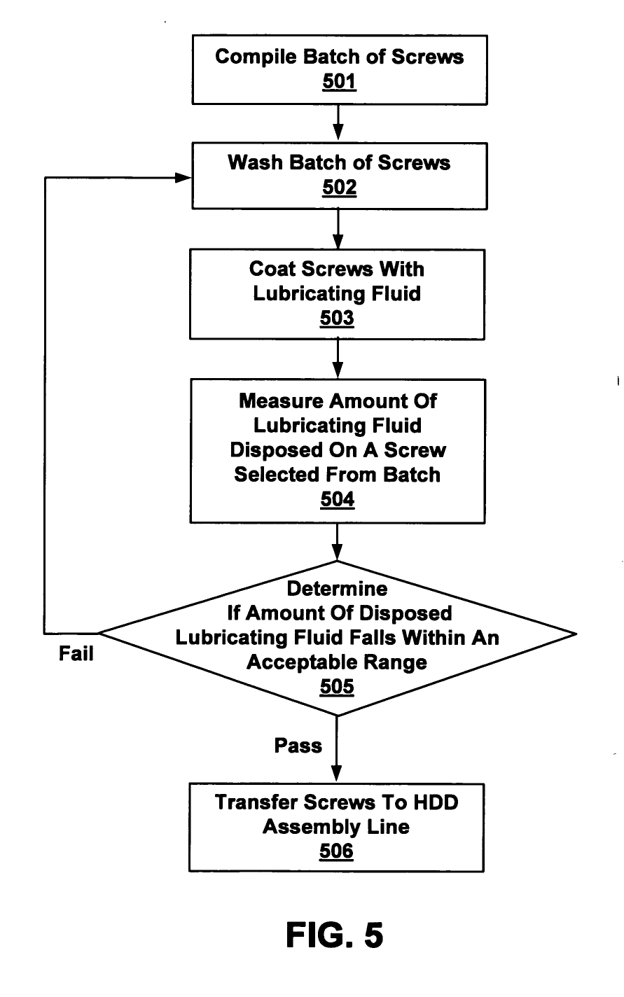

FIG. 5 shows a quality control process for monitoring the amount of lubricating fluid applied to HDD screws in accordance with one embodiment of the present invention. Referring to FIG. 5, in step 501, a batch of HDD screws are grouped that may ultimately be used in HDDs if they pass the lubricating fluid quantity test. In step 502, the batch of screws is washed to remove any undesirable deposits before the lubricating fluid is applied. The washing may be performed in one embodiment by a washing system (e.g., washing system 320 shown in FIG. 3). Subsequently, in step 503, the screws are coated with lubricating fluid. In one embodiment, the screws may be coated with a lubricating fluid application system (e.g., lubricating fluid application system 330 shown in FIG. 3).

Referring again to FIG. 5, the amount of lubricating fluid disposed on a screw selected from the batch of screws is measured in step 504. It should be understood that one or more screws are selected from the batch for testing in accordance with embodiments of the present invention. In one embodiment, this measuring may be performed by a lubricating fluid quantity testing system (e.g. lubricating fluid quantity testing system 340 shown in FIG. 3).

In step 505 it is determined whether the amount of lubricating fluid disposed on the selected screw or screws falls within an acceptable range. If the amount of lubricating fluid is not acceptable, then the whole batch, excluding the screw or screws tested, is rewashed, recoated, and re-measured in accordance with steps 502, 503, and 504. If the amount of lubricating fluid is acceptable, then the whole batch, excluding the screws tested, is sent to HDD assembly lines (e.g., HDD assembly lines 350 shown in FIG. 3) for use in the assembly of HDDs in step 506.

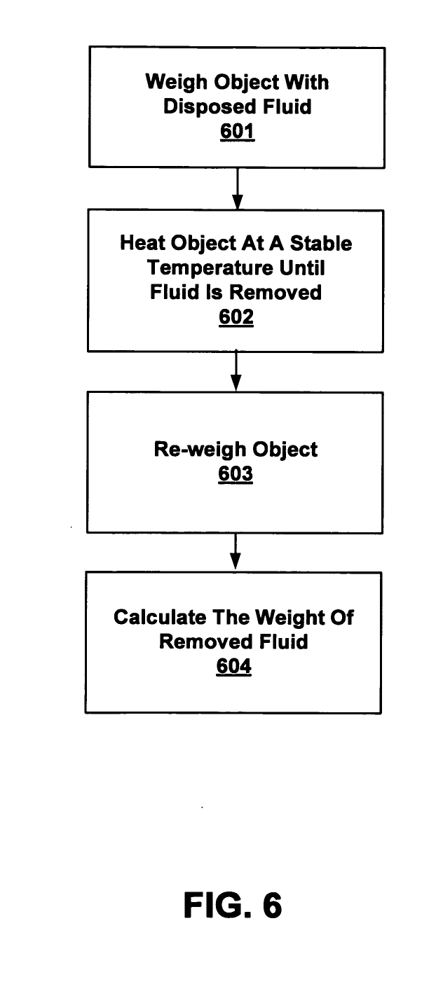

FIG. 6 shows a method for measuring the amount of the fluid disposed on an object or objects selected from a batch of objects in accordance with one embodiment of the present invention. In one embodiment of the present invention, the object may include, but is not limited to, a screw. Additionally, in one embodiment of the present invention, the fluid may include, but is not limited to, lubricating fluid.

Referring to FIG. 6, in step 601, an object with fluid disposed thereon is weighed. The weighing may be performed in one embodiment by a weighing system (e.g., weighing system 420 shown in FIG. 4). In one embodiment, in step 601, screws with lubricating fluid disposed thereon may be weighed individually. In another embodiment, screws with lubricating fluid disposed thereon may be weighed simultaneously. Thus, embodiments of the present invention represent a significant advantage over conventional methods limited to testing a single screw, as embodiments of the present invention allow multiple screws to be weighed before being heated, thereby increasing the speed, accuracy, and consistency of the process.

In step 602, the weighed object or objects are heated at a substantially constant temperature until all fluid disposed on the object or objects is removed. The heating in step 602 is performed in one embodiment by a heating system (e.g., heating system 440 shown in FIG. 4). It should be understood that a substantially constant temperature, as used in step 602, shall involve only slight variations of the substantially constant temperature throughout heating. Moreover, it should be understood that this substantially constant temperature is maintained from the point at which heating is initiated.

For example, in one embodiment, heating system 440 utilizes an oven preheated to a desired temperature. In this embodiment, weighed screws with lubricating fluid disposed thereon are placed in the preheated oven until all lubricating fluid is removed. In another embodiment, heating system 440 utilizes a micro-flame jet. The micro-flame jet is directed toward weighed screws with lubricating fluid disposed thereon until all lubricating fluid is removed. In both of these embodiments of the present invention, the time required to remove the lubricating fluid is greatly reduced since the heat source is not heated from room temperature.

Consequently, the time to test weighed screws with lubricating fluid disposed thereon is reduced from about 30 minutes in some conventional systems, to about one minute with embodiments of the present invention. Moreover, embodiments of heating system 440 of the present invention allow the heating of multiple screws, which significantly reduces the time to remove the lubricating fluid. For example, instead of it taking five hours to heat ten screws with a conventional system, embodiments of present invention can heat the ten screws in as little as one minute if heated simultaneously or as little as ten minutes if heated individually. Thus, embodiments of the present invention significantly reduce the time it takes to heat one or more objects until all the fluid disposed thereon is removed.

In step 603 of FIG. 6, the object or objects are reweighed to determine the amount of fluid removed from the object or objects. The weighing may be performed in one embodiment by a weighing system (e.g., weighing system 420 shown in FIG. 4). In one embodiment, the objects may be weighed individually. And in another embodiment, the objects may be weighed simultaneously.

In step 604, in one embodiment the objects can be weighed individually and the weight of the object after the fluid is removed can be subtracted from the weight of the object obtained previously when the object was coated with fluid. The result represents the amount of fluid on the object. In another embodiment the objects can be weighed simultaneously and the weight of the objects after the fluid is removed can be subtracted from the weight of the objects obtained previously in step 601 when the objects were coated with fluid. This result is then averaged such that the amount of fluid disposed on each object is estimated.

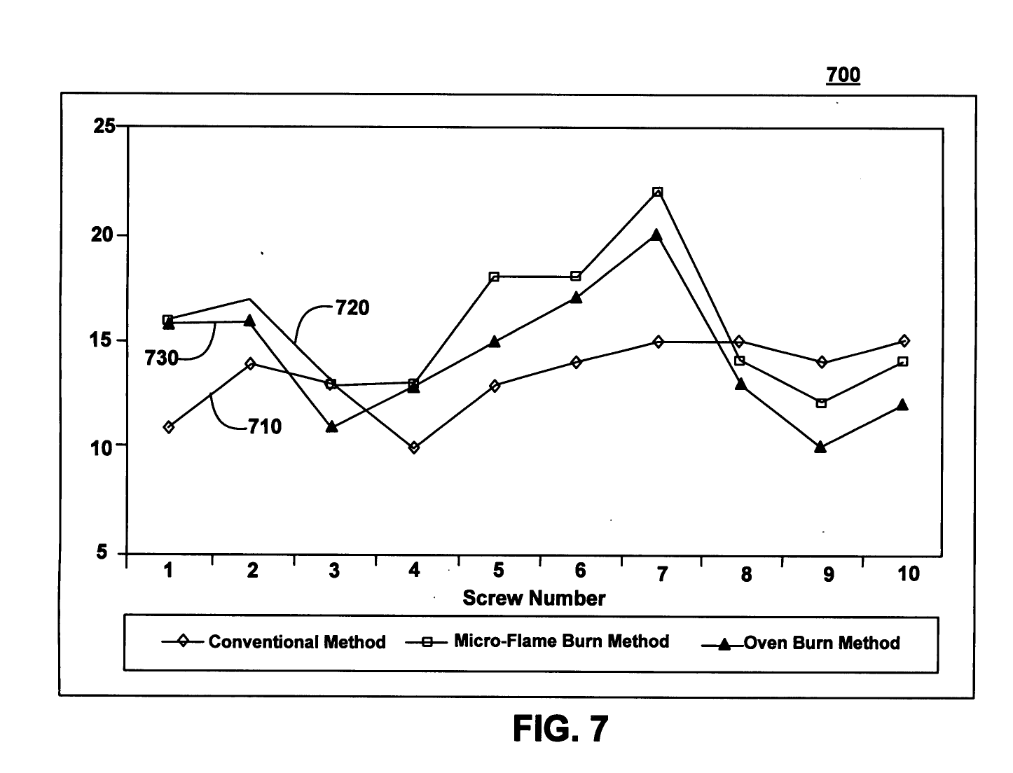

FIG. 7 shows graph 700 comparing the weight loss due to removal of lubricating fluid when using a conventional method and embodiments of the present invention. In one embodiment, a “micro-flame burn method” involves the use of the micro-flame jet, and an “oven burn method” involves the use of a preheated oven. Referring to FIG. 7, graph 700 shows the weight loss for the 30 screws tested, where ten screws were tested using each of the three methods. Conventional method dataset graph 710 shows the weight loss associated with the ten screws subjected to a conventional testing method. Micro-flame burn method dataset graph 720 shows the weight loss associated with the ten screws subjected to the micro-flame burn testing method. Oven burn method dataset graph 730 shows the weight loss associated with the ten screws subjected to the oven burn testing method.

The results shown in FIG. 7 are not intended to provide a precise measure of the performance of exemplary embodiments of the present invention. Rather, the results of FIG. 7 show merely that embodiments of the present invention significantly reduce testing duration while providing reasonable accuracy and precision as compared to conventional methodologies.

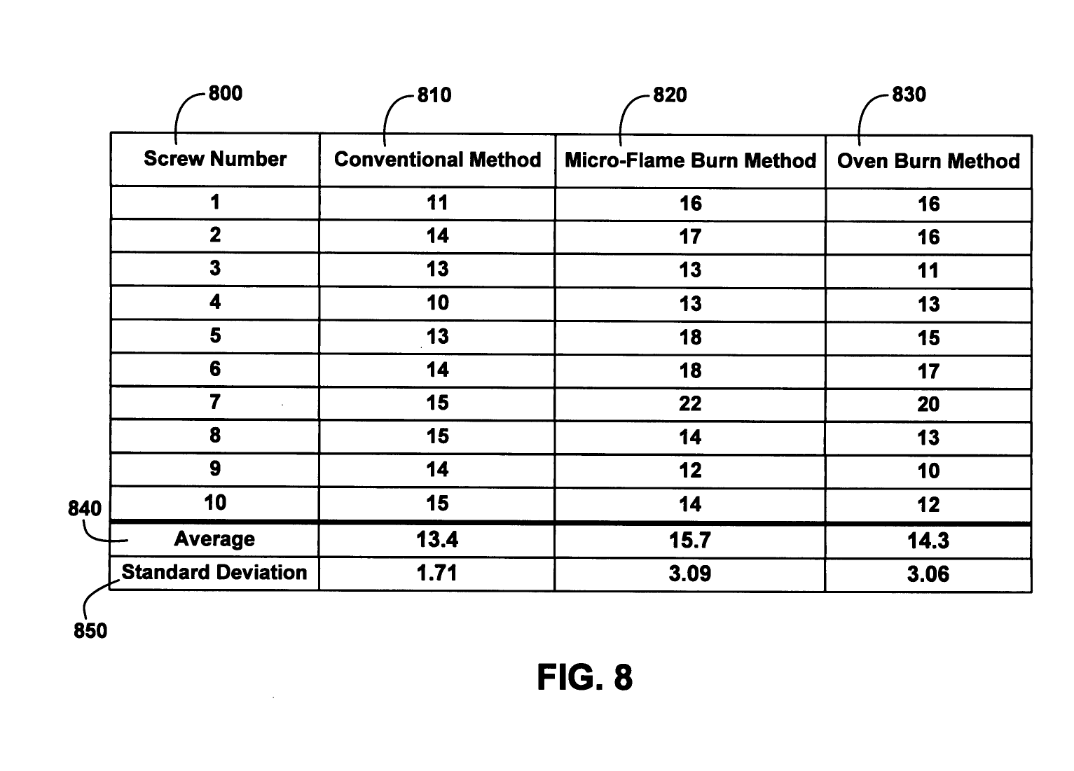

FIG. 8 shows a table of the data presented in the graph of FIG. 7, which compares the weight loss due to removal of lubricating fluid when using a conventional method and when using embodiments of the present invention. Conventional method dataset 810 shows the weight loss associated with ten screws subjected to the conventional testing method. Micro-flame burn method dataset 820 shows the weight loss associated with ten screws subjected to the micro-flame burn testing method. Oven burn method dataset 830 shows the weight loss associated with ten screws subjected to the oven burn testing method.

FIG. 8 also includes some statistical data relating to conventional method dataset 810, micro-flame burn method dataset 820, and oven burn method dataset 830. Average 840 shows the average weight loss of all the screws tested using each testing method. And, standard deviation 850 shows the standard deviation for the data corresponding to each testing method. As explained previously with respect to FIG. 7, the data in FIG. 8 is not intended to provide a precise measure of the performance of embodiments of the present invention. Rather, the results of FIG. 8 show merely that embodiments of the present invention produce comparable results to those of conventional systems while significantly reducing testing duration.

The alternative embodiment(s) of the present invention are thus described. While the present invention has been described in particular embodiments, it should be appreciated that the present invention should not be construed as limited by such embodiments, but rather construed according to the below claims.

What is claimed is:

1. A method for measuring the amount of fluid disposed on an object comprising:
weighing said object, wherein said object has fluid disposed thereon;
heating said object at a substantially constant temperature until all said fluid disposed thereon is removed, wherein said substantially constant temperature is maintained from the point at which said heating is initiated;
re-weighing said object; and
calculating the weight of said fluid disposed thereon by subtracting the weight of said object after heating from the weight of said object before heating.

2. The method of claim 1, wherein said object is a fastener.

3. The method of claim 2, wherein said fastener is a hard disk drive screw.

4. The method of claim 1, wherein said disposed fluid is lubricating fluid.

5. The method of claim 1, wherein said heating is provided by an oven.

6. The method of claim 1, wherein said heating is provided by a flame.

7. The method of claim 1, wherein said object is one of a plurality of said objects that are heated simultaneously.

8. A method for monitoring the amount of lubricating fluid disposed on hard disk drive screws, said method comprising:
compiling a batch of screws;
washing said batch of screws to remove undesirable deposits;
coating said batch of screws with said lubricating fluid;
selecting a screw from said batch of screws;
measuring the amount of said lubricating fluid disposed on said selected screw, wherein said measuring comprises:
weighing said selected screw with said lubricating fluid disposed thereon;
heating said selected screw at a substantially constant temperature until all said lubricating fluid disposed thereon is removed, wherein said substantially constant temperature is maintained from the point at which said heating is initiated;
re-weighing said selected screw; and
calculating the weight of said lubricating fluid disposed thereon by subtracting the weight of said selected screw after heating from the weight of said selected screw before heating;
determining whether the amount of said lubricating fluid disposed on said selected screw falls within an acceptable range; and
transferring said batch of screws, excluding said selected screw, to the hard disk drive assembly line for use in the assembly of hard disk drives.

9. The method of claim 8, wherein a determination that the amount of said lubricating fluid disposed on said selected screw falls outside said acceptable range requires said batch of screws to repeat said method for monitoring, beginning with said washing.

10. The method of claim 8, wherein said heating is provided by an oven.

11. The method of claim 8, wherein said heating is provided by a flame.

12. A system for measuring the amount of fluid disposed on an object comprising:
a heating system for heating said object at a substantially constant temperature until all said fluid disposed thereon is removed, wherein said substantially constant temperature is maintained from the point at which said heating is initiated;
a weighing system, wherein a change in weight is determined by weighing said object before and after said fluid disposed thereon is removed, and wherein said amount of said fluid disposed thereon is equal to said change in weight.

13. The system of claim 12, wherein said object is a fastener.

14. The system of claim 13, wherein said fastener is a hard disk drive screw.

15. The system of claim 12, wherein said disposed fluid is lubricating fluid.

16. The system of claim 12, wherein said heating system is an oven.

17. The system of claim 12, wherein said heating system is a flame.

18. A method for measuring the amount of fluid disposed on an object comprising:
weighing a plurality of said objects with said fluid disposed thereon;
heating said plurality of said objects at a substantially constant temperature until all said fluid disposed thereon is removed, wherein said substantially constant temperature is maintained from the point at which said heating is initiated;
re-weighing said plurality of said objects;
calculating the weight of said fluid disposed thereon by subtracting the weight of said plurality of said objects after heating from the weight of said plurality of said objects before heating; and
averaging said calculated weight to determine the amount of said fluid disposed on each of said objects.

19. The method of claim 18, wherein said object is a fastener.

20. The method of claim 19, wherein said fastener is a hard disk drive screw.

21. The method of claim 18, wherein said disposed fluid is lubricating fluid.

22. The method of claim 18, wherein said heating is provided by is an oven.

23. The method of claim 18, wherein said heating is provided by a flame.
